(19) United States
(12) Patent Application Publication
(10) Pub. No.: US 2002/0109043 A1
(43) Pub. Date: Aug. 15, 2002

(54) Flight vehicle having internal lift surfaces

(76) Inventor: Tianfu Li, Troy, MI (US)

Correspondence Address: Tianfu Li, 1103 Winthrop Dr., Troy, MI, 48083, US

(21) Appl. No.: 09/781,094

(22) Filed: Feb. 12, 2001

(51) Int. Cl. B64C 15/00; B64C 29/00

(52) U.S. Cl. 244/12.2

(57) ABSTRACT

A vehicle capable of roadway travel and flight, both in an atmosphere and in a vacuum, includes a fluid passageway, a device for producing fluid flow in the passageway, and airfoil surfaces spaced mutually along the passageway and fixed to the structure of the vehicle, to which structure lift forces produced on the airfoils are transferred. The vehicle includes lift-producing wings extending from the body of the vehicle, the fluid passageway being located within the vehicle body or the external wings. Fluid flow within the passageway is produced by a fan, propeller, or exhaust from a jet engine.

### BACKGROUND OF THE INVENTION

1. Field of the Invention

This invention relates to the field of flight vehicles, including spacecraft and aircraft, particularly to devices for developing and controlling lift for such vehicles.

2. Description of the Prior Art

Various techniques have been developed to produce a lifting force for an aircraft by producing a high-speed airstream within the craft. These techniques generally force the airstream from the craft at various locations and in various directions either to lift the craft by a force in reaction to a turbine force resulting from a the change in the direction of the airstream as it leaves the aircraft, or to drive a wing or other lifting surface rotating through a fluid medium, or by directing the airstream over an airfoil surface that produces lift.

U.S. Pat. No. 4,606,515 describes a hybrid airship, a lighter-than-air vehicle having pairs of tubes arranged diametrically and mutually perpendicular within a circular body. Doors selectively open and close the tubes so that the propulsive force produced by jet engines located in each tube is directed to maneuver the airship and change its direction or course of travel.

U.S. Pat. No. 5,203,521 describes an aircraft body having a central passageway, a fluid drive to accelerate fluid in the passageway, an upper deflector located above the passageway to direct fluid from the passageway outward across an airfoil surface of the body, and a collector located below the passageway for directing some fluid circulating around and under the body to the fluid drive and directing another portion of fluid downward away from the body.

U.S. Pat. No. 5,503,351 describes a rotary wing aircraft such as a helicopter having a fuselage and a circular wing assembly mounted above the fuselage. An air impeller is driven to rotate within the wing assembly to produce lift and forward flight of the aircraft.

U.S. Pat. No. 5,765,776 discloses a planform wing having upper and lower surfaces supported for rotation in a fluid medium, and a Coanda perimeter along which pressurized fluid is ejected downward into the fluid medium. A nozzle, formed in the upper surface near the Coanda perimeter, ejects fluid from angularly spaced locations along the perimeter. A control valve supplies pressurized fluid to the nozzle to restrict ejection to various combinations of the spaced locations.

### SUMMARY OF THE INVENTION

A flight vehicle having internal airfoils for producing lift according to this invention includes a body that supports fluid forces and inertia loads imposed by the vehicle and its contents; passageways containing fluid, enclosed within and supported on said body, each passageway having a cross sectional area surrounded by a surface and defining a path along which the fluid flows in the passageway; a device for producing a stream of the fluid along the passageway; and multiple airfoil surfaces located in the stream of fluid flowing in the passageways, spaced mutually along the passageways, supported on the surrounding surface, each airfoil surface having a leading edge facing upstream and a trailing edge facing downstream, producing lift directed substantially vertically upward as the fluid stream flows in the passageways over the airfoil surfaces.

Alternatively the passageways may be replaced by a first duct containing fluid, enclosed within and supported on said body, said first duct having a cross sectional area surrounded by a surface and defining a substantially closed circuit through which the fluid continuously recirculates in a first direction; and a second duct containing fluid, located above the first duct, enclosed within and supported on said body, the second duct having a cross sectional area surrounded by a surface and defining a substantially closed circuit through which the fluid continuously recirculates in a second direction opposite the first direction.

In this alternate embodiment, the multiple airfoil surfaces are located in the stream of fluid flowing in the ducts, spaced mutually along the ducts, supported on the surrounding surface, each airfoil surface having a leading edge facing upstream and a trailing edge facing downstream, and produce lift directed substantially vertically as said fluid streams flow in the first and second ducts across the airfoil surfaces.

### BRIEF DESCRIPTION OF THE DRAWING

FIG. 1 is a side view of a flight vehicle according to this invention.

FIG. 2 is top view of the flight vehicle of FIG. 1.

FIG. 3 is a schematic top view of a flight vehicle having a fluid duct located on each lateral side of the vehicle.

FIG. 4 is a schematic side view of the vehicle of FIG. 3.

FIG. 5 is a schematic end view of the vehicle of FIGS. 3 and 4.

FIG. 6 is a schematic end view of a flight vehicle having a centrally located fluid duct.

FIG. 7 is an isometric view of oblong fluid flow ducts suitable for use with a vehicle according to this invention, the elongated dimension preferably extending along the longitudinal axis of the vehicle.

FIG. 8 is an isometric view of circular fluid ducts and airfoils for use with a vehicle according to this invention.

FIG. 9 is side view of an airfoil typical of the type located in the fluid ducts of FIGS. 7 and 8.

FIG. 10 is a side view of an air regulator located in a fluid duct.

### DESCRIPTION OF THE PREFERRED EMBODIMENT

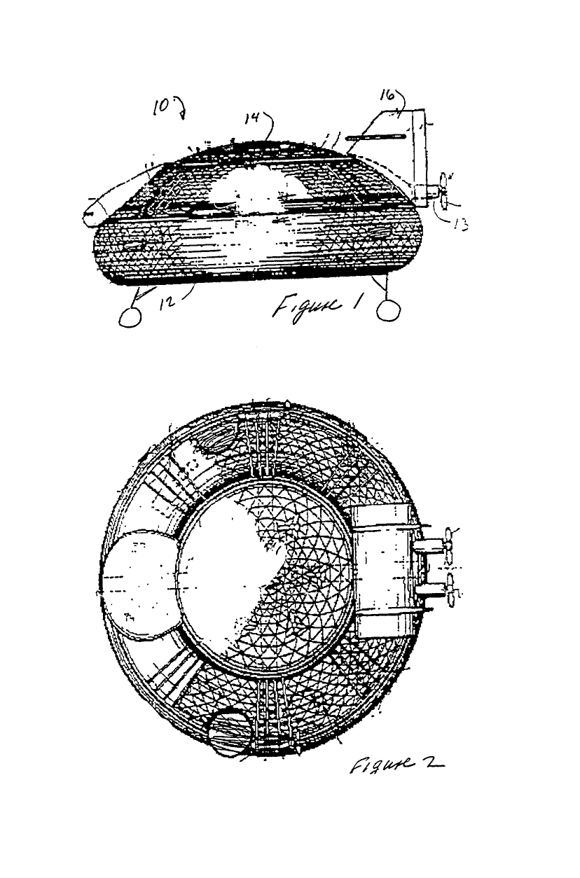

Referring first to FIGS. 1 and 2, a flight vehicle 10 according to this invention includes a base portion 12, which may be circular or elongated in the direction that extends along the longitudinal axis of the vehicle, and a dome portion 14 located above the base. The attitude of the craft is controlled partially by a rudder 16, and its main forward propulsion provided by a propeller 18 driven by an engine. The vehicle is supported on the ground by wheels suited for travel on a roadway or by landing gear that is retractable during flight.

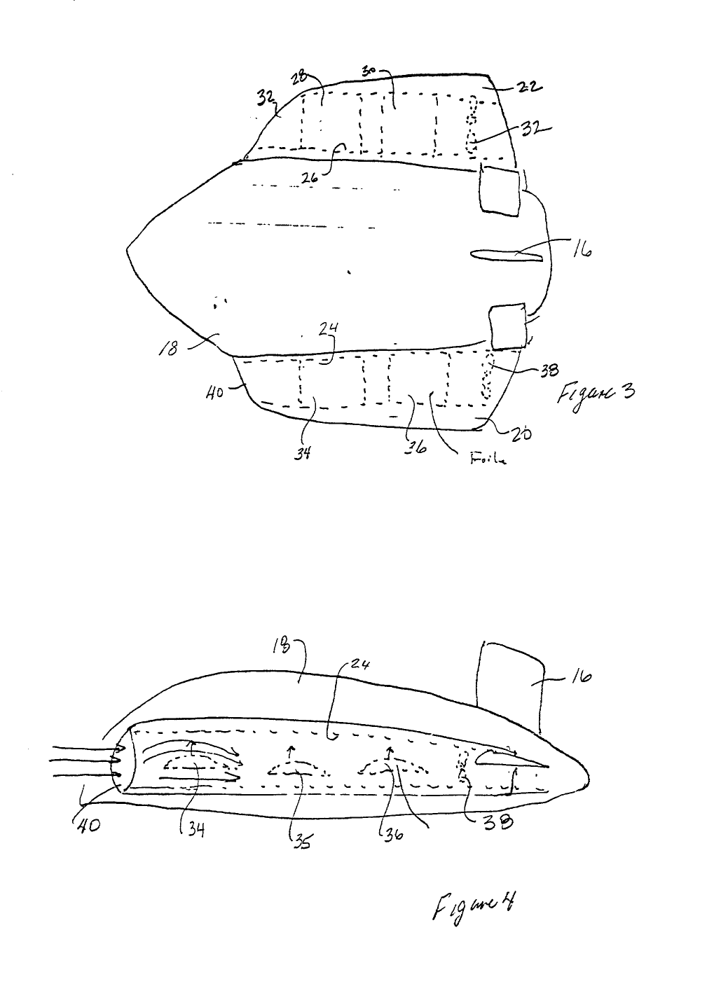

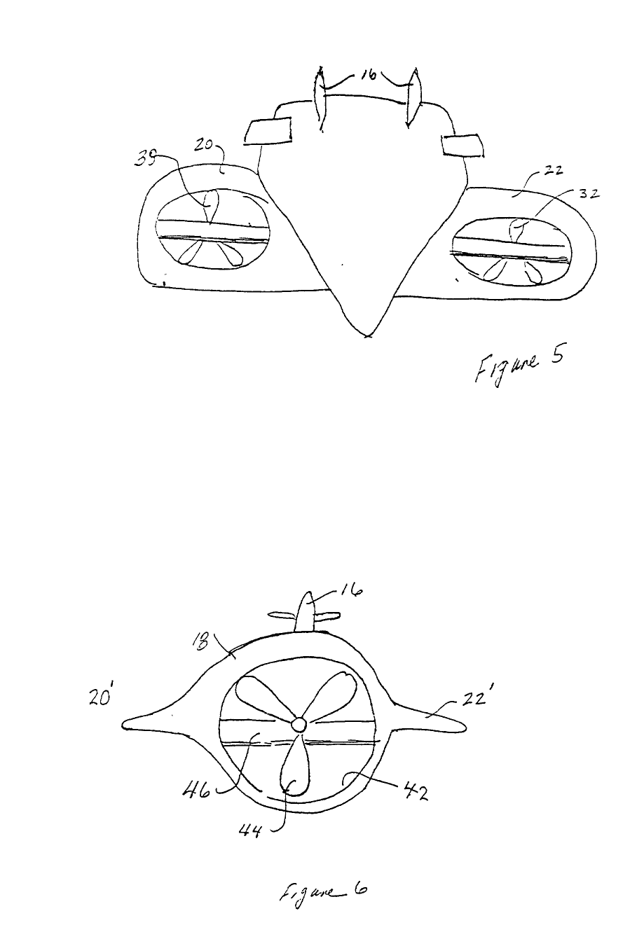

FIGS. 3-5 illustrate a flight vehicle having a body or fuselage 18, the structure of the vehicle that supports aerodynamic forces, the forces of other fluids, and inertia loads imposed by the weight of the vehicle and its contents; wings 20, 22 extending laterally from each side of the fuselage; and fluid flow ducts 24, 26, each duct located in and extending longitudinally within a wing on opposite lateral sides of the fuselage.

Located with the right-hand side duct 26 are airfoils 28, 30, spaced axially along the length of the duct 26, and a propeller or bladed fan 32, suited to draw fluid into, along and through the duct at relatively high speed, the speed being sufficient to produce substantial lift on the airfoils located in the ducts. The propeller is driven by an engine or motor. Alternately a secondary fluid stream can enter the duct near its exit and be used to draw fluid into duct 26 at its entrance 32 near the leading edge of wing 22.

Located with the left-hand side duct 24 are airfoils 34, 36, spaced axially along the length of duct 24, and a propeller or bladed fan 38 driven by an engine and suited to draw fluid into, along and through the duct at relatively high speed. Alternately, a secondary fluid stream can enter the duct near its exit and be used to draw fluid into duct 24 at its entrance 40 near the leading edge of wing 20. Preferably the device for producing the fluid stream is able to produces a fluid stream whose speed relative to the airfoils is variable. The direction of the fluid stream relative to the airfoils is preferably variable also.

FIG. 6 shows an end view of a flight vehicle having one longitudinal fluid flow duct 42, airfoils 46 located in and spaced along the length of the duct, and a propeller or bladed fan 44 driven by an engine and suited to draw fluid into, along and through the duct at relatively high speed.

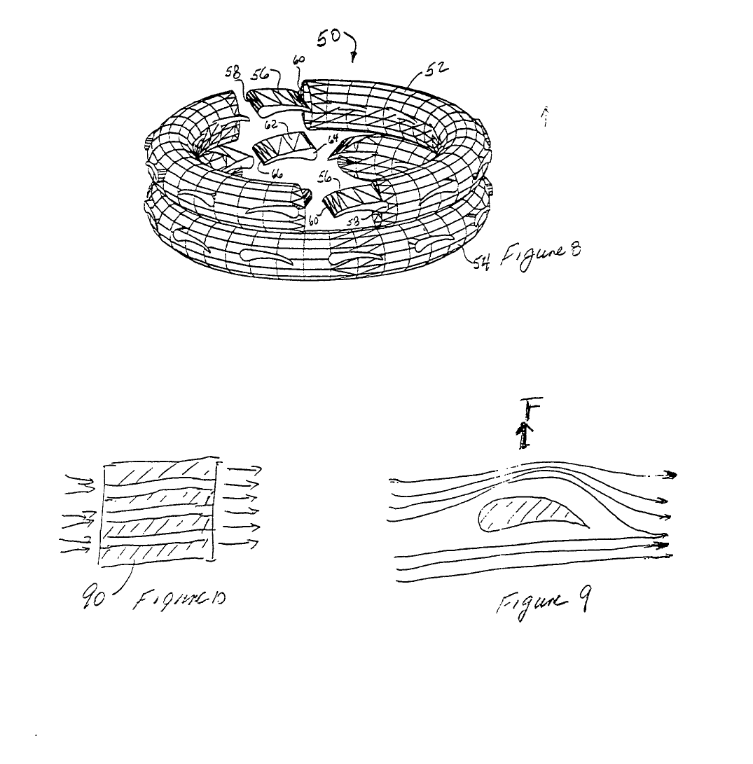

FIG. 9 schematically shows an airfoil in cross section and the fluid stream in a fluid flow duct passing over the airfoil. Each of the airfoils located in the fluid ducts has such a shape that the force exerted on it by fluid flow through the associated duct has a larger component substantially normal to the direction of fluid motion than along the direction of fluid motion, such as the wing of an airplane or the blade of a propeller. In this way each of these airfoils produces a substantial lift force or aerodynamic lift-that component of the total fluid force acting on a body perpendicular to the undisturbed flow relative to the body.

The airfoils are supported structurally on the fuselage of the flight vehicle; therefore the lift forces produced on the airfoils operate to produce substantially vertical lift (either positive or negative) on the vehicle. The magnitude of the lift is affected by the speed of the fluid stream in the ducts, the cross sectional shape of the airfoil, the angle of attack of the airfoil relative the fluid stream in the duct, the presence and disposition of spoilers, flaps and other conventional control surfaces, such as those used to control a winged aircraft. Preferably each airfoil includes members of the group of parameters consisting of chordal length, thickness, cross sectional shape, and planform shape, any or all of these parameters being variable.

Referring to FIG. 8, a lift producing device 50 includes an upper fluid flow passageway or duct 52, a lower duct 54, each duct having the form of a torus having a circular cross section, each duct containing a gaseous or liquid fluid. During operation, the fluid contained in each duct remains there and circulates continuously around the path defined by the ducts, the direction of rotation in the upper duct 52 preferably being opposite to that of the lower duct 54. The ducts are arranged to be located within the base portion 12 of the flight vehicle of FIG. 1.

Airfoils 56, supported on the walls of the duct 52, are spaced mutually along the length of the duct and arranged so that the leading edge 58 of each airfoil faces upstream toward the oncoming direct of fluid flow in the duct 52, and the trailing edge 60 faces downstream. The direction of fluid flow in the upper duct 52 is clockwise when viewed from above. Similarly airfoils 62, supported on the walls of the duct 54, are spaced mutually along the length of the duct and arranged so that the leading edge 64 of each airfoil faces upstream toward the oncoming direct of counterclockwise fluid flow in duct 54, and the trailing edge 66 faces downstream.

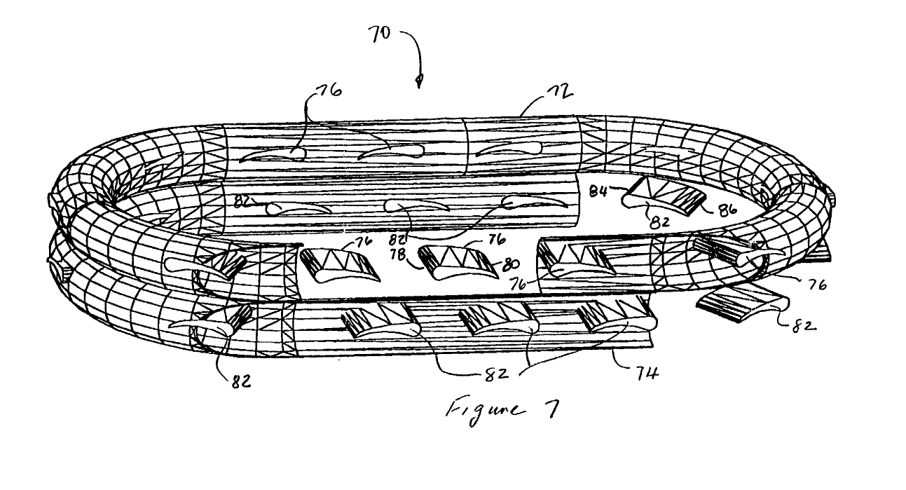

An alternate embodiment of a lift device 70, that shown in FIG. 7, includes an upper fluid flow passageway or duct 72, a lower duct 74, each duct having an elongated dimension extending longitudinally parallel to the vehicle axis, each duct 72, 74 containing a gaseous or liquid fluid. During operation, the fluid contained in each duct circulates continuously around the path defined by the ducts, the direction of rotation in the upper duct 52 preferably being opposite to that of the lower duct 54. The ducts are arranged to be located within the base portion 12 of the flight vehicle of FIG. 1, thereby giving the vehicle a greater length than its lateral width.

Lifting airfoils 76, supported on the walls of the upper duct 72, are spaced mutually along the length of the duct and arranged so that the leading edge 78 of each airfoil faces upstream toward the oncoming direct of fluid flow in duct 72, and the trailing edge 80 faces downstream. In this case, the direction of fluid flow in upper duct 72 is clockwise when viewed from above. Similarly airfoils 82, supported on the walls of the duct 54, are spaced mutually along the length of the duct and arranged so that the leading edge 84 of each airfoil faces upstream toward the oncoming direct of counterclockwise fluid flow in duct 74, and the trailing edge 86 faces downstream.

A fluid flow regulator, such as that of FIG. 10, may be located in each fluid flow duct to attenuate airsteam disturbance, turbulence and vortices produced as the fluid steam travels through the ducts over the airfoils in the ducts. The regulator can be in the form of horizontal slots formed in a block located in the fluid stream in the duct.

A rotating fan or propeller may be located in the ducts to maintain flow of fluid through the ducts continually during operation when fluid in the gaseous state is used, or a pump or turbine may be used for that purpose when hydraulic fluid flows in the ducts. Preferably the device for producing the fluid stream is able to produces a fluid stream whose speed relative to the airfoils is reversible and variable. The direction of the fluid stream relative to the airfoils is preferably variable also.

Preferably the angle of attack (the angle between a fixed reference line and the direction of movement of fluid in the duct) of the airfoils can be controlled and changed with the requirements of the vehicle. For example, the angle of attack can be increased when a large magnitude of lift is required, reduced to reduce lift, and reversed in direction to produce negative lift. The speed of fluid flow in the ducts can be increased to increased lift, reduced to decrease lift, and reversed. Preferably each airfoil includes members of the group of parameters consisting of chordal length, thickness, cross sectional shape, and planform shape, any or all of these parameters being variable.

Accordingly the vehicle is capable of flight in air using external planform wings extending outward from the fuselage, augmented by additional lift produced by airfoil surfaces located in ducts through which fluid passes at high speed. The flight vehicle of this invention can also function in space or another environment having little or no atmosphere by generating the needed lift solely by passing high-speed fluid over airfoils located in fluid flow ducts, in which the fluid continually flows and recirculates in a continuous, enclosed path.

Although the form of the invention shown and described here constitutes the preferred embodiment of the invention, it is not intended to illustrate all possible forms of the invention. Words used here are words of description rather than of limitation. Various changes in the form of the invention may be made without departing from the spirit and scope of the invention as disclosed.

I claim:

1. A flight vehicle having internal airfoils for producing lift, comprising:
a body that supports fluid forces and inertia loads imposed by the vehicle and its contents;
passageways containing fluid, enclosed within and supported on said body, each passageway having a cross sectional area surrounded by a surface and defining a path along which the fluid flows in the passageway;
a device for producing a stream of the fluid along the passageways; and
multiple airfoils located in the stream of fluid flowing in the passageways, spaced mutually along the passageways, supported on the surrounding surface, each airfoil having a leading edge facing upstream and a trailing edge facing downstream, producing lift directed substantially vertically as the fluid stream flows in the passageways over the airfoils.

2. The flight vehicle of claim 1 wherein the device for producing a stream of fluid is a member of the group consisting of a fan, propeller, jet engine, and pump.

3. The flight vehicle of claim 2 wherein the device for producing a stream of fluid produces a fluid stream whose speed relative to the airfoils is variable.

4. The flight vehicle of claim 2 wherein the device for producing a stream of fluid produces a fluid stream whose direction relative to the airfoils is variable.

5. The flight vehicle of claim 1 wherein each airfoil has an angle of attack that can be varied with respect to said fluid stream.

6. The flight vehicle of claim 1 wherein each airfoil includes members of the group of parameters consisting of chordal length, thickness, cross sectional shape, and planform shape, any of said parameters being variable.

7. The flight vehicle of claim 1 further comprising a fluid flow regulator located in said fluid flow stream in the passageway and located between said airfoils.

8. The assembly of claim 1 further comprising:
first and second external wings, each wing extending outward from opposite lateral sides of the body; and
wherein the passageways comprise
a first passageway located in and extending longitudinally along the first wing, having a inlet located near a leading extremity of a wing and an outlet located near a trailing extremity of a wing, the direction of fluid flow in the first passageway being from the inlet to the outlet; and
a second passageway located in and extending longitudinally along the second wing, having an inlet located near a leading surface of a wing and an outlet located near a trailing surface of a wing, the direction of fluid flow in the second passageway being from the inlet to the outlet.

9. A flight vehicle having internal airfoils for producing lift, comprising:
a body that supports fluid forces and inertia loads imposed by the vehicle and its contents;
a first duct containing fluid, enclosed within and supported on said body, said first duct having a cross sectional area surrounded by a surface and defining a substantially closed circuit through which the fluid continuously recirculates in a first direction;
a second duct containing fluid, located above the first duct, enclosed within and supported on said body, the second duct having a cross sectional area surrounded by a surface and defining a substantially closed circuit through which the fluid continuously recirculates in a second direction opposite the first direction.
a device for producing a stream of the fluid in the first duct and a stream of fluid in the second duct; and
multiple airfoils located in said stream of fluid flowing in the ducts, spaced mutually along the ducts, supported on the surrounding surface, each airfoil having a leading edge facing upstream and a trailing edge facing downstream, producing lift directed substantially vertically as said fluid streams flow in the first and second ducts across the airfoils.

10. The flight vehicle of claim 9 wherein the first and second ducts have a planform shape that is substantially annular.

11. The flight vehicle of claim 9 wherein the first and second ducts have a planform shape that is oblong, having an elongated dimension directed substantially along a longitudinal axis of the vehicle.

12. The flight vehicle of claim 9 wherein the device for producing a stream of fluid is a member of the group consisting of a fan, propeller, jet engine, and pump.

13. The flight vehicle of claim 12 wherein the device for producing a stream of fluid produces a fluid stream whose speed relative to the airfoils is variable.

14. The flight vehicle of claim 12 wherein the device for producing a stream of fluid produces a fluid stream whose direction relative to the airfoils is reversible.

15. The flight vehicle of claim 9 wherein each airfoil includes members of the group of parameters consisting of chordal length, thickness, cross sectional shape, and planform shape, any of said parameters being variable.

16. The flight vehicle of claim 1 wherein each airfoil has an angle of attack that can be varied with respect to said fluid stream.

17. The flight vehicle of claim 9 further comprising a fluid flow regulator located in fluid flow streams in the first and second ducts and located between said airfoils.

18. The assembly of claim 9 further comprising:
first and second external wings, each wing extending outward from opposite lateral sides of the body; and
wherein the first duct and second duct have a planform shape that is substantially annular.

19. The flight vehicle of claim 9 further comprising:
first and second external wings, each wing extending outward from opposite lateral sides of the body; and
wherein the first duct and second duct have a planform shape that is substantially oblong, having an elongated dimension directed substantially along a longitudinal axis of the vehicle.

20. A flight vehicle having internal airfoils for producing lift, comprising:
a body that supports fluid forces and inertia loads imposed by the vehicle and its contents;
a passageway containing fluid, enclosed within and supported on said body, having a cross sectional area surrounded by a surface and defining a path along which the fluid flows in the passageway;
a device for producing a stream of the fluid along the passageway; and
multiple airfoils located in the stream of fluid flowing in the passageway, spaced mutually along the passageway, supported on the surrounding surface, each airfoil having a leading edge facing upstream and a trailing edge facing downstream, producing lift directed substantially vertically as the fluid stream flows in the passageways over the airfoils.
